(19) United States
(12) Patent Application Publication
(10) Pub. No.: US 2010/0286019 A1
(43) Pub. Date: Nov. 11, 2010

(54) Spray Drying Process

(76) Inventors: Herbert B. Scher, Moraga, CA (US); Deborah S. Winetzky, Foster City, CA (US)

Correspondence Address: DANISCO US INC.;ATTENTION: LEGAL DEPARTMENT, 925 PAGE MILL ROAD, PALO ALTO, CA, 94304, US

(21) Appl. No.: 12/522,733

(22) PCT Filed: Jan. 11, 2008
(86) PCT No.: PCT/US2008/000418

§ 371 Date: Feb. 22, 2010

Related U.S. Application Data
(60) Provisional application No. 60/884,860, filed on Jan. 12, 2007.

(51) Int. Cl. C11D 3/386; B29B 9/00; C11D 3/22; C11D 3/37

(52) U.S. Cl. 510/393; 264/5; 510/473; 510/475; 510/490

(57) ABSTRACT

The present invention generally relates to particulate compositions and methods for making the compositions. It specifically relates to improved spray drying methods that substantially reduce the production of small particles that pose industrial hygiene concerns for factory workers and product consumers. In a composition aspect, the present invention provides an atomized aqueous composition. The composition is formed using a spray-drying apparatus. It includes 0.001 to 0.10 weight percent of a polymer, which is selected from a group consisting of a cellulose-based polymer, a gum, and a synthetic polymer. It further includes at least one polypeptide, which is present in the aqueous composition at a concentration greater than 0.01 weight percent.

### CROSS-REFERENCE TO RELATED APPLICATIONS

This application claims the benefit of U.S. Provisional Application No. 60/884,860, filed on Jan. 12, 2007, which is hereby incorporated by reference herein in its entirety.

### FIELD OF THE INVENTION

The present invention generally relates to particulate compositions and methods for making the compositions. It specifically relates to improved spray drying methods that substantially reduce the production of small particles that pose industrial hygiene challenges for factory workers and product consumers.

### BACKGROUND

Polypeptides such as pharmaceutically important proteins and industrially important enzymes are widely used. Polypeptides and proteins may be included in product compositions such as drugs and personal care products. Enzymes, for example, are included in product compositions for several industries, such as the starch industry, the baking industry, the dairy industry, the textile industry, the food industry and the detergent industry. It is well known in these industries that the use of enzymes has created industrial hygiene concerns due to the production of inspirable enzyme particles (i.e., ≦100 μm).

Since the introduction of commercially important polypeptides into various industries, there have been many developments concerning the manufacture of polypeptide-containing particles.

U.S. Pat. No. 5,423,997 discusses a spray dried, phosphate-free ultra concentrated powdered automatic dishwashing detergent composition containing a mixture of a protease enzyme and an amylase enzyme. The detergent includes a nonionic surfactant, an alkali metal silicate, a phosphate-free builder system, a peroxygen compound with activator as a bleaching agent, and a mixture of amylase and protease enzymes.

U.S. Pat. No. 6,146,879 discusses a method for spray-drying whole microorganisms of Fusarium lateritium, Methylophilus methylotrophus and Pseudomonas putida. Spray drier inlet temperatures of 140° C. to 250° C. are reported for aqueous feeds containing the microorganisms (e.g., not purified enzymes). The process is conducted such that feeds are subjected to elevated temperatures for a period ranging from 15 to 45 seconds.

U.S. Pat. No. 6,544,763 discusses enzyme granules having an average particle size of from 150 to 500 μm and a bulk density of from 500 to 1,000 g/L. The granules are prepared by spray-drying a slurry containing: 1) a water insoluble substance and or a slightly water soluble substance that is present to the extent of 45 percent by weight or more; 2) a water soluble binder; and, 3) an enzyme. Listed examples of component “1” include cellulose powder, zeolites, talc, clay, alumina, kaolin, titania, calcium carbonate, and barium sulfate.

U.S. Pat. No. 6,924,133 discusses a process for preparing an enzyme-containing particle. The process involves spray drying a liquid containing an enzyme and biomass. Typically, the liquid is a fermentation broth or a processed fermentation broth. Additives such as salts, inorganic materials, carbohydrates, coloring pigments, cellulose, biocides and dispersants may be added to the liquid material prior to spray drying.

Liquid enzyme compositions obtained prior to or following recovery processes may contain heterogeneous materials having a variety of molecular weights, including, but not limited to materials with molecular weights below about 250,000 Daltons. For example, some liquid enzyme compositions may contain some heterogeneous combinations that may include DNA fragments, or soy and raw starches used in fermentation processes. Such heterogeneous materials may be removed using conventional enzyme recovery techniques. Heterogeneous materials remaining in enzyme solutions have not been shown to substantially reduce the production of small particles in spray drying processes.

### BRIEF SUMMARY OF THE INVENTION

The present invention generally relates to particulate compositions and methods for making the compositions. It specifically relates to improved spray drying methods that substantially reduce the production of small particles that pose industrial hygiene challenges for factory workers and product consumers.

In a composition aspect, the present invention provides an atomized aqueous composition. The composition is formed using a spray-drying apparatus. It includes 0.001 to 0.10 weight percent of a high molecular weight (MW), water soluble, flexible polymer, which is selected from a group consisting of a cellulose-based polymer, a gum, and a synthetic polymer. It further includes at least one polypeptide, which is present in the aqueous composition at a concentration greater than 0.01 weight percent.

In certain cases, the cellulose-based polymer is carboxymethylcellulose having a molecular weight ranging from 300,000 to 500,000.

In certain cases the at least one polypeptide is an enzyme. The enzyme may be any suitable one including an oxidoreductase, a transferase, a hydrolase, a lyase, an isomerase and a ligase.

In another composition aspect, the present invention provides a particle. The particle is a product of a spray-drying procedure. It includes 0.002 weight percent to 1.0 weight percent, 0.002 to 0.9 weight percent, 0.002 to 0.8 weight percent, 0.002 to 0.7 weight percent, 0.002 to 0.6 weight percent, and 0.002 to 0.5 weight percent of a high molecular weight, water soluble, flexible polymer, which is selected from a group consisting of a cellulose-based polymer, a gum, and a synthetic polymer. Particular weight percents are 0.005 weight percent to 0.8 weight percent, 0.01 weight percent to 0.50 weight percent or 0.025 weight percent to 0.25 weight percent. It further includes at least one polypeptide, which is present in the particle at a concentration greater than 0.5 weight percent.

In certain cases, the polymer is a cellulose-based polymer having a molecular weight ranging from 300,000 to 500,000.

In certain cases, the polymer is carboxymethylcellulose included at a concentration ranging from 0.01 weight percent to 0.25 weight percent.

In certain cases, the polypeptide is an enzyme selected from a group consisting of oxidoreductases, transferases, hydrolases, lyases, isomerases and ligases. The enzyme is typically present at a concentration greater than 1.0 weight percent.

In a method aspect, the present invention provides a method for increasing the yield of a spray-drying process. The process provides a particle that includes a polypeptide at a concentration greater than 0.5 weight percent. The method includes the following steps: a) feeding an aqueous composition into a spray-drying apparatus, wherein the aqueous composition comprises 0.001 to 0.10 weight percent of a high molecular weight, water soluble, flexible polymer and at least one polypeptide, wherein the polymer is selected from a group consisting of a cellulose-based polymer, a gum, and a synthetic polymer, and, wherein the at least one polypeptide is present in the aqueous composition at a concentration greater than 0.01 weight percent; and, b) spray-drying the composition. The particle yield is increased at least 5 percent over the same process where the polymer is not included in the aqueous composition.

In certain cases, the process comprises bringing the aqueous composition in contact with a spray-drying apparatus inlet which has an inlet temperature ranging from 140° C. to 200° C.

In certain cases, the process involves bringing the aqueous composition in contact with a nozzle on the spray-drying apparatus, where the outlet temperature of the apparatus ranges from 50° C. to 150° C.

In another method aspect, the present invention provides a method of manufacturing a particle. The particle includes a polypeptide in a concentration greater than 0.5 weight percent. The method includes the following steps: a) feeding an aqueous composition into a spray-drying apparatus, wherein the aqueous composition comprises 0.001 to 0.10 weight percent, preferably 0.001 to 0.08%, 0.001 to 0.05%, or 0.001 to 0.03% of a high MW, water soluble, flexible polymer and at least one polypeptide, wherein the polymer is selected from a group consisting of a cellulose-based polymer, a gum, and a synthetic polymer, and wherein at least one polypeptide is present in the aqueous composition at a concentration greater than 0.01 weight percent; b) spray-drying the composition to provide particles; and, c) collecting the particles for further processing. The typical spray-drying apparatus includes a downstream filter or filter bag that traps fine particles. The frequency with which the downstream filter or filter bag is cleaned is reduced by at least 10 percent relative to the same process where the aqueous composition does not comprise a polymer.

In certain cases, the process involves bringing the aqueous composition in contact with a nozzle on the spray-drying apparatus, where the outlet temperature of the apparatus ranges from 50° C. to 150° C.

In certain cases the polypeptide is an enzyme selected from a group consisting of oxidoreductases, transferases, hydrolases, lyases, isomerases and ligases.

In certain cases the polymer is cellulose-based and has a molecular weight between 300,000 and 500,000.

In certain cases, the frequency with which the filter bag is cleaned is reduced by at least 20 percent relative to the same process where the aqueous composition does not include a polymer.

In another method aspect, the present invention provides a method of spray-drying an aqueous composition that contains a polypeptide. The method includes the following steps: a) feeding an aqueous composition into a spray-drying apparatus, wherein the composition comprises 0.001 to 0.10 weight percent, preferably 0.001 to 0.08%, 0.001 to 0.05%, or 0.001 to 0.03% of a polymer having a molecular weight ranging from 300,000 Daltons to 4,000,000 Daltons, preferably from 300,000 Daltons to 2,000,000 Daltons and at least one polypeptide, and wherein the at least one polypeptide is present in the aqueous composition at a concentration greater than 0.01 weight percent; and, b) spray drying the aqueous composition.

In certain cases, the polymer is carboxymethylcellulose.

In certain cases, the process involves bringing the aqueous composition in contact with a nozzle on the spray-drying apparatus, where the outlet temperature of the apparatus ranges from 50° C. to 150° C.

In certain cases the polypeptide is an enzyme selected from a group consisting of oxidoreductases, transferases, hydrolases, lyases, isomerases and ligases.

In another composition aspect, the present invention provides a particle for inclusion in detergent compositions (see cosmetic example below). The particle is produced through a spray-drying process. The process includes the following steps: a) feeding an aqueous composition into a spray-drying apparatus, wherein the composition comprises 0.001 to 0.10 weight percent preferably 0.001 to 0.08%, 0.001 to 0.05%, or 0.001 to 0.03% of a non-peptide-based polymer having a molecular weight ranging from 300,000 Daltons to 4,000,000 Daltons, preferably from 300,000 Daltons to 2,000,000 Daltons and at least one polypeptide, and wherein the at least one polypeptide is present in the aqueous composition at a concentration greater than 0.01 weight percent; and, b) spray drying the aqueous composition.

In another composition aspect, the present invention provides a particle for inclusion in a nutritional supplement. The particle for the nutritional supplement is produced through a spray-drying process. The process includes the following steps: a) feeding an aqueous composition into a spray-drying apparatus, wherein the composition comprises 0.001 to 0.10 preferably 0.001 to 0.08%, 0.001 to 0.05%, or 0.001 to 0.03% weight percent of a non-peptide-based polymer having a molecular weight ranging from 300,000 Daltons to 4,000,000 Daltons, preferably from 300,000 Daltons to 2,000,000 Daltons and at least one polypeptide, and wherein the at least one polypeptide is present in the aqueous composition at a concentration greater than 0.01 weight percent; and, b) spray drying the aqueous composition.

In another composition aspect, the present invention provides a particle for inclusion in a cosmetic composition. The particle is produced through a spray-drying process. The process includes the following steps: a) feeding an aqueous composition into a spray-drying apparatus, wherein the composition comprises 0.001 to 0.10 preferably 0.001 to 0.08%, 0.001 to 0.05%, or 0.001 to 0.03% weight percent of a non-peptide-based polymer having a molecular weight ranging from 300,000 Daltons to 4,000,000 Daltons, preferably from 300,000 Daltons to 2,000,000 Daltons and at least one polypeptide, and wherein the at least one polypeptide is present in the aqueous composition at a concentration greater than 0.01 weight percent; and, b) spray drying the aqueous composition.

In another composition aspect, the present invention provides a composition containing a peptide-based drug. The peptide-based drug component of the composition is produced through a spray-drying process. The process includes the following steps: a) feeding an aqueous composition into a spray-drying apparatus, wherein the composition comprises 0.001 to 0.10 preferably 0.001 to 0.08%, 0.001 to 0.05%, or 0.001 to 0.03% weight percent of a non-peptide-based polymer having a molecular weight ranging from 300,000 Daltons to 4,000,000 Daltons, preferably from 300,000 Daltons to 2,000,000 Daltons and at least one peptide-based drug, and wherein the at least one peptide-based drug is present in the aqueous composition at a concentration greater than 0.01 weight percent; and, b) spray drying the aqueous composition.

### BRIEF DESCRIPTION OF THE DRAWINGS

FIG. 1 shows a schematic diagram of a spray drying apparatus having the following components: air intake (1); heater (2); flow stabilizer (3); cyclone (4); aspirator (5); temperature sensor (air inlet, 6); temperature sensor (air outlet, 7); container for collecting finished product (8); bag filter (9); vacuum gauge (10); spray chamber receiver (11); and, nozzle (12).

FIG. 2 shows the results from spray drying of enzyme in the presence of high molecular weight polymer, as described in Example 4.

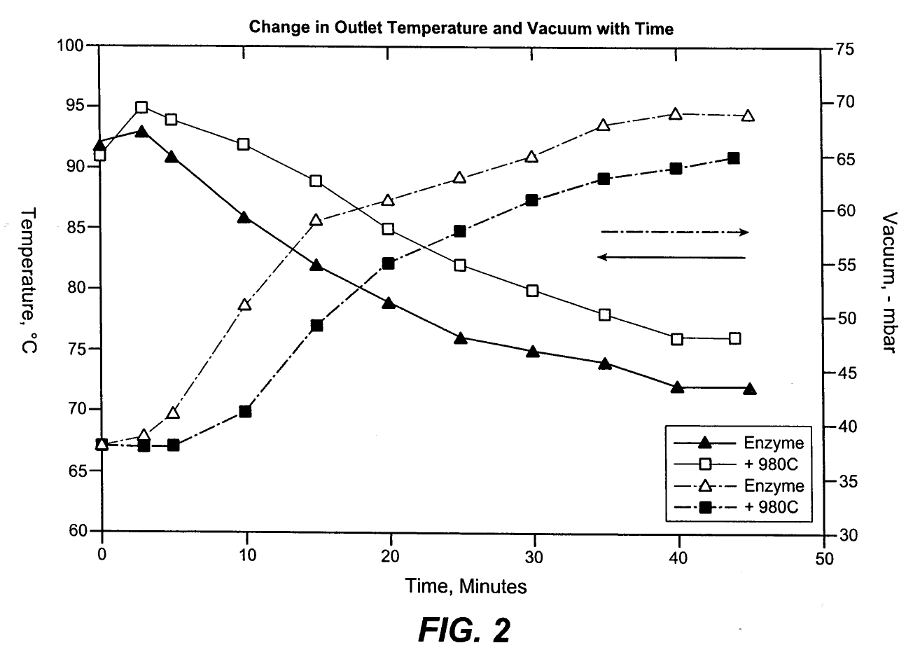

### DETAILED DESCRIPTION

Unless defined otherwise herein, all technical and scientific terms used herein have the same meaning as commonly understood by one of ordinary skill in the art to which this invention belongs. Various references (See e.g., Singleton, et al., Dictionary of Microbiology and Molecular Biology, 2d Ed., John Wiley and Sons, New York [1994]; Hale and Marham, The Harper Collins Dictionary of Biology, Harper Perennial, NY [1991]; and McCutcheons Functional Materials, vols 1 & 2, Mc Publishing Company, published yearly) provide general definitions of many of the terms used herein. Furthermore, all patents and publications, including all sequences disclosed within such patents and publications, referred to herein are expressly incorporated by reference.

The term “Dv” means a measure of particle or droplet diameter. Dv10 represents the particle diameter below which 10% of the aerosol spray volume is contained. Dv50 represents the volume median diameter (vmd) such that 50% of the spray volume is contained in droplets larger than the vmd and 50% of the spray volume is contained in droplets smaller than the vmd. Dv90 represents the particle diameter above which 10% of the spray volume is contained.

The term “flexible” polymer, as opposed to a rigid polymer, means that the flexible polymer will stretch, deform and be capable of building elongational viscosity in a solution, while a rigid polymer generally has covalent bonds that will not allow the polymer to stretch, deform or build elongational viscosity in a solution.

The term “high molecular weight polymer” as used herein means a water-soluble organic molecule consisting of many repeating segments called monomers or “mers” wherein the molecular weight is at least greater than about 300,000 Daltons, and preferably greater than about 400,000 Daltons. The molecular weight of a high molecular weight polymer is measured by using well-known chemical and physical methods. These methods include colligative property measurement, light-scattering techniques, GPC analysis, ultra centrifugation and the like.

The term “viscosity” means the ratio of stress to velocity gradient and includes two forms: shear viscosity (ηs) and elongational viscosity (ηe). Shear viscosity represents the resistance of adjacent layers in a liquid sliding over each other and elongational viscosity represents resistance of the fluid to being stretched or contracted.

While not meant to be limited to any particular theory, it is believed that the mechanism of action of the high molecular weight polymers is to prevent the formation of fine droplets as a result of atomization in the spray dried process. This may be the result of an increase in either, or both, shear viscosity or elongational viscosity, but in general, elongational viscosity has the greater effect.

Spray-Drying

Particle drying according to the present invention is performed through a spray-drying process. In its most basic form, the process involves the following: transporting a liquid or suspension through an atomizing device into a drying chamber; mixing droplets of the atomized liquid or suspension with a stream of heated air; evaporating volatile components of the droplets in the stream of air leaving dried particles.

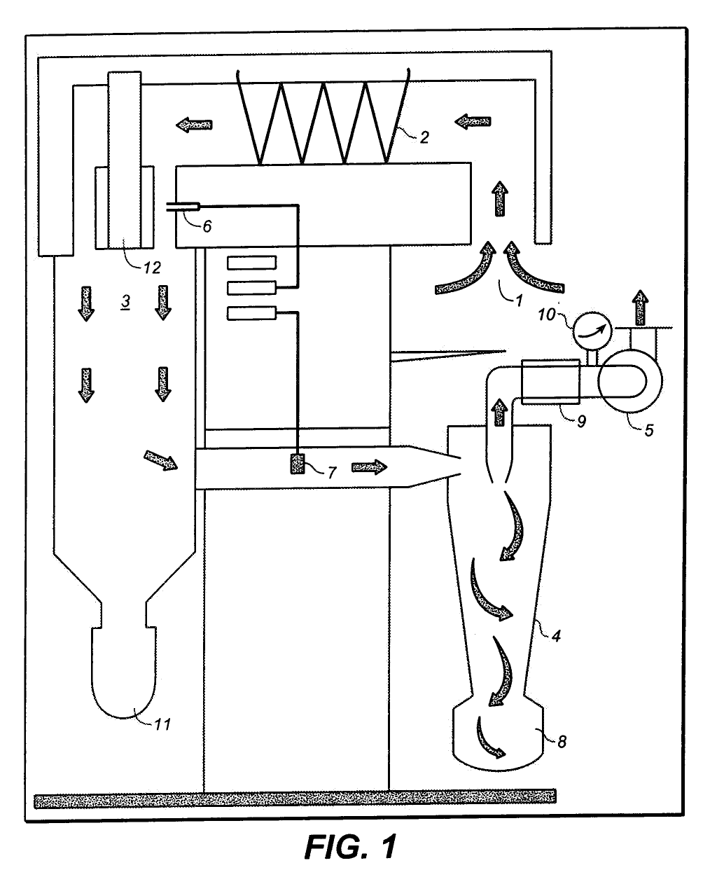

The liquid/suspension transport is typically accomplished using a pump. The pump moves the material to an inlet (1) of a spray-drying apparatus (FIG. 1), which has an associated air inlet temperature (“T₁”). Transportation of the liquid/suspension through an atomizer (i.e., nozzle, 12) provides an aerosol that emerges from the atomizer outlet. The nozzle may be cooled (e.g., water cooled). The emerging aerosol is further subjected to heated air flowing either in the same,_co-current, direction or in the opposite, counter-current direction, and is pulled through the drying chamber due to gravity and air flow. Particles formed upon evaporation of the volatile components—typically water—are collected at the exit, or may be separated from the air flow by a cyclone and collected in a container. The temperature of the air measured at the exit of the spray dryer or entering the cyclone is the outlet temperature (“Tₒ”). Fine particulate matter oftentimes travels past the collection container and is caught in a filter bag situated after it. On the small scale spray dryer used in the experiments described in the following sections, a vacuum gauge that is situated between the filter bag and an aspirator pump that pulls the air through the dryer reads the vacuum pressure on the pump side of the filter bag. An increase in the vacuum, e.g. from −35 mbar to −70 mbar, implies an increase in resistance across the filter bag due to the accumulation of fine particles.

In, for example, a Buchi bench-top spray dryer, Tᵢ typically ranges from 140° C. to 200° C. Oftentimes T₁ ranges from 150° C. to 190° C. or from 160° C. to 180° C.

The atomizer may be of any suitable type. Non-limiting examples of atomizers include high speed rotating disk atomizers, pressure nozzle atomizers, pneumatic nozzle atomizers, and sonic nozzle atomizers.

The solution or suspension fed into the spray-drying apparatus comprises a liquid and a polymer. Typically, the liquid is water; the high molecular weight, water soluble, flexible polymer is usually selected from a group of polymers consisting of cellulose-based polymers, gums and synthetic polymers. Non-limiting examples of cellulose-based polymers include hydroxypropyl cellulose and carboxymethyl cellulose; examples of gums include guar gum, and xanthan gum; synthetic polymers include, without limitation, polyethylene oxide, polyacrylamide, and a copolymer of polyacrylamide and sodium acrylate.

The molecular weight (i.e., MW) of the included polymer may be of any suitable range. Typically, the MW ranges from 300,000 Daltons to 4,000,000 Daltons, preferably from 300,000 Daltons to 2,000,000 Daltons. The polymer is typically included in the liquid or suspension at a concentration ranging from 0.001 weight percent to 0.10, preferably 0.001 to 0.08%, 0.001 to 0.05%, or 0.001 to 0.03% weight percent.

The solution or suspension fed into a spray-drying apparatus further typically comprises at least one type of polypeptide. Polypeptides included in the solution or suspension may be of a variety of types, including proteins (e.g., naturally occurring proteins and enzymes), protein fragments, protein variants, and synthetic polypeptides.

Where an enzyme is included, it may be any enzyme or combination of different enzymes one can obtain by fermentation, recombinant technologies or laboratory synthesis. An enzyme may be naturally occurring or a variant of a naturally occurring enzyme. Examples of enzyme variants are disclosed, for example, in the following documents: EP 251,446 (Genencor), WO 91/00345 (Novo Nordisk), EP 525,610 (Solvay) and WO 94/02618 (Gist-Brocades NV).

Non-limiting examples of enzymes used in aspects of the present invention include: oxidoreductases (e.g., peroxidases such as haloperoxidase and laccases, and glucose oxidases); transferases (e.g., transferases transferring one-carbon group, transferases transferring aldehyde or ketone residues, acyltransferases, glycosyltransferases, transferases transferring aryl groups or alkyl groups other than methyl, and transferases transferring nitrogenous groups); hydrolases (e.g., carboxylic ester hydrolases such as lipases, phytases such as 3-phytases and 6-phytases, glycosidases which are included in carbohydrases such as alpha-amylases, peptidases/proteases, and other carbonyl hydrolases); lyases; isomerases; and, ligases.

Further examples of specific enzymes are as follows: transglutamase, including transglutamases described in WO 96/06931 to Novo Nordisk A/S (transferases); α-amylases, f3-amylases (3.2.1.2), glucan 1,4-α-glucosidases (3.2.1.3), cellulases (3.2.1.4), endo-1,3(4)-β-glucanases, endo-1,4-β-xylanases, dextranases, chitinases, polygalacturonases, lysozymes, β-glucosidases, α-galactosidases, β-galactosidases, amylo-1,6-glucosidases, xylan xylosidases, glucan endo-1,3-β-D-glucosidases, α-dextrin endo-1,6-α-glucosidases, sucrose α-glucosidases, glucan endo-1,3-α-glucosidases, glucan 1,4-β-glucosidases, glucan endo-1,6-β-glucosidases, arabinan endo-1,5-α-L-arabinosidases, lactases, chitosanases, and xylose isomerases (carbohydrases); Gluzyme™ (oxidoreductase available from Novo Nordisk A/S); Kannase™, Everlase™, Esperase™, Alcalase™, Neutrase™, Durazym™, Savinase™, Pyrase™, Pancreatic Trypsin NOVO (PTN), Bio-Feed™ Pro and Clear-Lens™ Pro (proteases/peptidases available from Novo Nordisk A/S, Bagsvaerd, Denmark); Maxatase™, Maxacal™, Maxapem™, Opticlean™ and Purafect™ (proteases available from Genencor International Inc. or Gist-Brocades); Lipoprime™, Lipolase™, Lipolase™ Ultra, Lipozyme™, Lumafast™ (Pseudomonas mendocina lipase from Genencor International Inc.); Lipomax™ (Ps. pseudoalcaligenes lipase from Gist-Brocades/Genencor Int. Inc.); and Bacillus sp. (lipase from Solvay enzymes); α-Gal™, Bio-Feed™ α, Bio-Feed™ β, Bio-Feed™ Plus, Novozyme™ 188, Celluclast™, Cellusoft™, Ceremyl™, Citrozym™, Denimax™, Dezymer™, Dextrozyme™, Finizym™, Fungamyl™, Gamanase™, Glucanex™, Lactozym™, Maltogenase™, Pentopan™, Pectinex™, Promozyme™, Pulpzyme™, Novamyl™, Termamyl™, AMG™ (Amyloglucosidase Novo), Maltogenase™, Sweetzyme™ and Aquazym™ (carbohydrases all available from Novo Nordisk A/S).

An enzyme-containing liquid or suspension used in the present invention may be, for example, a fermentation broth or processed fermentation broth.

A fermentation broth includes microbial cells and/or related cell debris (i.e., biomass). Some or most of the biomass may be removed from the fermentation broth to modify properties of the broth for spray drying. Typically, at least 10 percent by weight to 20 percent by weight of the biomass is removed from the broth prior to spray drying. Oftentimes, at least 30 percent, 40 percent, 50 percent, or 60 percent of the biomass is removed, and in certain cases at least 70 percent, 80 percent, 90 percent, or 95 percent of the biomass is removed.

Biomass may be removed from the fermentation broth using a variety of techniques. Such techniques include filtration, centrifugation, flocculation and combinations thereof.

Typically, the fermentation broth includes between 0 and 35 percent weight/weight dry matter. Oftentimes, the broth includes between 0 and 20 percent weight/weight dry matter or between 0 and 15 percent weight/weight dry matter. In certain cases, the fermentation broth includes between 5 percent and 15 percent weight/weight dry matter. Up to 90 percent weight/weight of the dry matter is biomass. Oftentimes, up to 75 percent, 50 percent or 25 percent weight/weight of the dry matter is biomass. In certain cases, up to 10 percent weight/weight of the dry matter is biomass.

The fermentation broth may be de-sludged through the removal of coarse particles or bodies. Such particles/bodies include straw, rubble, soy grits and other non-biomass insolubles that typically originate from nutrients added to the broth during fermentation. Removal is typically accomplished by one of the following methods: straining, filtration, sedimentation, centrifugation and/or decanting the broth.

Where a solution or suspension containing an enzyme is used in the present invention, the liquid medium is typically water. For instance, the enzyme-containing material may be an enzyme concentrate obtained from fermentation filtrate processing. Processing methods used to concentrate the fermentation broth include, without limitation: ultra filtration to reduce water content and low molecular components; extraction of the enzyme from the fermentation filtrate into a second liquid; crystallization or precipitation of the enzyme followed by resuspension and, purification through column chromatography may be used, e.g. by pumping the fermentation filtrate through a column comprising a resin.

Materials may be added to an enzyme-containing liquid to improve the properties of spray dried products obtained from the liquids. Non-limiting examples of such additives include: salts (e.g., alkali salts, earth metal salts, chloride salts, sulfate salts, nitrate salts, carbonate salts, where exemplary counterions are calcium, potassium, and sodium), inorganic minerals or clays (e.g., zeolites, kaolin, bentonite, talc's and/or silicates), carbohydrates (e.g., sucrose and/or starch), coloring pigments (e.g., titanium dioxide), biocides (e.g., Rodalon®, Proxel®), dispersants, anti foaming agents, acid agents, alkaline agents, enzyme stabilizers (e.g., methionine, or thiosulphate), enzyme inhibitors (e.g., boric acid protease inhibitors), binders other enzymes and combinations thereof. Polymeric additives typically are either low MW (<250,000 Daltons) materials, or are added as slurries where the additive is not in solution.

The enzyme-containing liquid may also be subjected to physical treatments prior to spray drying. Such physical treatments include, without limitation, heating and/or cooling and/or radiating the liquid, mixing the liquid, aerating the liquid, and ultra-sound treatment of the liquid.

Enzyme-containing liquids used in the present invention typically include at least 1 mg of “active” enzyme, e.g. catalytically active protein of interest, per liter of liquid. Oftentimes, the liquids include at least 3 mg, 5 mg or 10 mg of active enzyme per liter of liquid; in certain cases, the liquids include at least 20 mg, 50 mg, 75 mg or 80 mg per liter of liquid.

By including a high molecular weight, water soluble, flexible polymer in the solution or suspension fed into a spray-drying apparatus, the yield of particles post spray-drying is increased over that obtained with a solution or suspension not containing the polymer. Typically, the yield is increased at least 2.5 percent relative to the process where the polymer is not included. Oftentimes, the yield is increased at least 5.0 or 7.5 percent. In certain cases, the yield is increased at least 10.0 or 15.0 percent.

Increases in the yield are independent of the scale of the spray drying apparatus. For example, the Buchi bench-top spray dryer typically collects at least 1 g mass of particles. Oftentimes, the collection will have a mass of at least 100 g, at least 1 kg, at least 10 kg, at least 30 kg, at least 50 kg, or higher.

The weight percentage of high molecular weight, water soluble, flexible polymer in the particles ranges from 0.002 weight percent to 1.0 weight percent. Oftentimes, the weight percentage ranges from 0.005 weight percent to 0.8 weight percent, 0.01 weight percent to 0.50 weight percent or 0.025 weight percent to 0.25 weight percent.

By controlling the size range of particle collections, the present invention simplifies the manufacturing process for spray-drying compositions. For instance, during typical spray-drying manufacturing, the down stream filter or filter bag of a spray-drying apparatus must be emptied several times, since it becomes clogged with fine particulate matter. Because fewer fine particles are made in the process of the present invention, the down stream filter or filter bag of a spray-drying apparatus does not have to be emptied at the same rate as during typical spray-drying manufacturing processes. The decreased rate of emptying also reduces industrial hygiene concerns and manufacturing down time.

Typically, the down stream filter or filter bag must be emptied at least 5 percent less than during a typical process. Oftentimes, it must be emptied at least 10 percent or 15 percent less than during a typical process. In certain cases, it must be emptied at least 20 percent or 25 percent less than during a typical process.

Post Processing of Spray-Dried Particles

The spray-dried particles formed according to the present invention may be further processed using a variety of methods. Non-limiting examples of such methods include mixer granulation, prilling, extrusion, fluid bed processes, coating, and milling/grinding and screening.

Mixer granulation involves mixing spray dried particles with water and an additional component. Additional components are typically binders, fibers, salts, water insoluble minerals, pigments, enzyme stabilizers or combinations thereof. Water is added in amounts sufficient to agglomerate solid components into granules of a suitable mean size. The water is subsequently removed using a suitable drying method.

Binders used in a mixer granulation process for particles of the present invention are polymeric in nature. Exemplary binders include polyvinyl pyrrolidone, dextrins and cellulose derivatives (e.g., hydroxypropyl cellulose, methyl cellulose or carboxymethyl cellulose. Glucidex 21D, available from Roquette Freres, France, is oftentimes a suitable binder.

Fibers used in a mixer granulation process include pure and/or impure fibrous cellulose, such as sawdust, pure fibrous cellulose, and cotton. Filter aids based on fibrous cellulose can also be used. Examples of commercially available fibrous cellulose include Cepo™ and Arbocell™. Synthetic fibers as discussed in EP 304331 B1 may be used, including fibers made of polyethylene, polypropylene, polyester, especially nylon, polyvinylformate, poly(meth)acrylic compounds.

Salts used in a mixer granulation process include water soluble and/or insoluble salts such as alkali and/or earth alkali salts of sulfate, chloride, carbonate and phosphate.

Water insoluble minerals used in a mixer granulation process include zeolites, clays like kaolin and bentonite, talcs, and/or silicates.

Pigments used in a mixer granulation process include titanium dioxide.

Enzyme stabilizers used in a mixer granulation process include alkaline or neutral materials (e.g., metal silicates, carbonates or bicarbonates), reducing agents (e.g., sulfite, thiosulfite, or thiosulfate), antioxidants (e.g., methionine, butylated hydroxytoluene, or butylated hydroxyanisol) and/or salts of first transition series metal ions. These agents may be used in conjunction with other protective agents of the same or different categories.

A number of mixer granulation process are known in the art, including those discussed in the following documents: U.S. Pat. No. 4,106,991; EP 170360 B1; EP 304332 B1; EP 304331; WO 90/09440; and, WO 90/09428.

Prilling involves suspending dried particles in molten wax followed by spray cooling of the suspension. The process is discussed in Michael S. Showell (editor); Powdered detergents; Surfactant Science Series; 1998; vol. 71, page 140-142, Marcel Dekker; and, DK-PA 1999. A wax used in the prilling process has a melting point between 25 and 125° C. and is typically an organic compound or a salt of an organic compound. It oftentimes is either water soluble or water dispersible in a neutral or alkaline solution. Non-limiting examples of water soluble waxes are the polyethylene glycols (e.g., PEG 1000).

Extrusion involves adding moisture to particles, either alone or mixed with an additive as described for mixer granulation, to provide a paste. The paste is pressed into pellets or is extruded under pressure through a small opening; it is then cut into particles, which are dried. Extrusion processes are discussed in Michael S. Showell (editor); Powdered detergents; Surfactant Science Series; 1998; vol. 71, page 140-42, Marcel Dekker; and, U.S. Pat. No. 4,661,452.

Fluid bed processes involve fluidizing spray dried particles in a fluid bed. A solution containing a binder is atomized and brought into contact with the fluidized particles. This causes the particles to bind together, forming larger, stronger particles.

Spray dried particles of the present invention may be coated with one or more coating layers. Coatings and methods known in the art may be used, examples of which are discussed in the following documents: WO 89/08694; WO 89/08695; WO 00/01793; U.S. Pat. No. 4,106,991; EP 170360; EP 304332; EP 304331; EP 458849; EP 458845; WO 97/39116; WO 92/12645A; WO 89/08695; WO 89/08694; WO 87/07292; WO 91/06638; WO 92/13030; WO 93/07260; WO 93/07263; WO 96/38527; WO 96/16151; WO 97/23606; U.S. Pat. No. 5,324,649; U.S. Pat. No. 4,689,297; EP 206417; EP 193829; DE 434-4215; DE 4322229 A; DD 263790; JP 61162185 A; and, JP 58179492. The coating may include materials such as binders, fibers, salts, water insoluble materials, pigments, enzyme stabilizers or combinations thereof as described above in the mixer granulation section.

The processes described above may be supplemented with milling/grinding and/or screening processes at any stage. It may, for example, be desirable to grind the spray dried particles prior to subsequent processing steps and to screen the final product to obtain the desired size fraction.

Applications

The particles of the present invention are useful in a wide range of compositions and applications. Non-limiting examples of compositions include cleaning compositions (e.g., detergents and anti-microbial compositions), textile processing compositions (e.g., compositions for enzymatic bleach and/or stone washing of textiles), therapeutic compositions including a drug, leather processing compositions, pulp or paper processing compositions, food and beverage compositions (e.g., enzymatic compositions used in producing wine, oils, fats, citrus and juice products, starch and sugar products, alcohols and/or brewed products, soy products, baking flour, and dough), animal feed compositions and personal care compositions.

A detergent composition using particles of the present invention may be, for example, formulated as a hand or machine laundry detergent including appropriate additives. It may further be formulated as a detergent for general household cleaning purposes, or hand or machine dishwashing.

The detergent composition contains enzyme-containing particles prepared using the spray drying process as described herein. The enzyme is typically a protease, a lipase, a cutinase, an amylase, a carbohydrase, a cellulase, a pectinase, a mannanase, an arabinase, a galactanase, a xylanase, an oxidase, e.g., a laccase, and/or a peroxidase. An enzyme is included in an amount corresponding to 0.01 to 100 mg of enzyme per liter of wash liquor. Oftentimes, an enzyme is added in an amount corresponding to 0.05 to 5 mg of enzyme per liter or 0.1 to 1 mg of enzyme per liter of wash liquor.

Proteases that may be included in detergent compositions can be of animal, vegetable or microbial origin. The protease is oftentimes a serine protease or a metalloprotease, with an alkaline microbial protease or a trypsin-like protease. Subtilisins are an example of a class of alkaline proteases (e.g., subtilisins derived from Bacillus such as subtilisin Novo, subtilisin Carlsberg, subtilisin 309, subtilisin 147 and subtilisin 168. Trypsin and the Fusarium protease described in WO 89/06270 and WO 94/25583 are examples of trypsin-like proteases.

Specific proteases that may be used are the enzyme variants described in WO 92/19729, WO 98/20115, WO 98/20116, and WO 98/34946, especially the variants with substitutions in one or more of the following positions: 27, 36, 57, 76, 87, 97, 101, 104, 120, 123, 167, 170, 194, 206, 218, 222, 224, 235 and 274. Suitable commercially available proteases include Alcalase™, Savinase™, Primase™, Duralase™, Esperase™, and Kannase™ (Novo Nordisk A/S), Maxatase™, Maxacal™, Maxapem™, Properase™, Purafect™, Purafect OxP™, FN2™, and FN3™ (Genencor International Inc.).

Lipases that may be included in detergent compositions may be of bacterial or fungal origin. Suitable lipases—such as those from Humicola, H. insolens, P. alcaligenes, P. pseudoalcaligenes, P. cepacia, P. stuzeri and P. fluorescens—are described in the following documents: EP 258 068; EP 305 216; WO 96/13580; EP 218 272; EP 331 376; GB 1,372,034; WO 95/06720; WO 96/27002; WO 96/12012; Dartois et al. (1993), Biochemica et Biophysica Acta, 1131, 253-360); JP 64/744992; and, WO 91/16422. Examples of lipase variants are reported in WO 92/05249, WO 94/01541, EP 407 225, EP 260 105, WO 95/35381, WO 96/00292, WO 95/30744, WO 94/25578, WO 95/14783, WO 95/22615, WO 97/04079 and WO 97/07202. Commercially available lipase enzymes include Lipolase™ and Lipolase Ultra™ (Novo Nordisk A/S).

Amylases that may be included in detergent compositions may be of bacterial or fungal origin. A suitable lipase is α-amylase amylase obtained from Bacillus (discussed in GB 1,296,839). Specific amylases that may be used are the enzyme variants described in WO 94/02597, WO 94/18314, WO 96/23873, and WO 97/43424, especially the variants with substitutions in one or more of the following positions: 15, 23, 105, 106, 124, 128, 133, 154, 156, 181, 188, 190, 197, 202, 208, 209, 243, 264, 304, 305, 391, 408, and 444. Commercially available amylases include Duramyl™, Termamyl™, Fungamyl™ and BAN™ (Novo Nordisk A/S), Rapidase™ and Purastar™ (from Genencor International Inc.).

Cellulases that may be included in detergent compositions may be of bacterial or fungal origin. Cellulases from the genera Bacillus, Pseudomonas, Humicola, Fusarium, Thielavia and Acrmonium are suitable. Such cellulases are discussed in the following documents: U.S. Pat. No. 4,435,307, U.S. Pat. No. 5,648,263, U.S. Pat. No. 5,691,178, U.S. Pat. No. 5,776,757 and WO 89/09259. Oftentimes, the cellulose is an alkaline or neutral cellulose having color care benefits. Such cellulases are reported in EP 0 495 257, EP 0 531 372, WO 96/11262, WO 96/29397, WO 98/08940. Cellulase variants listed in WO 94/07998, EP 0 531 315, U.S. Pat. No. 5,457,046, U.S. Pat. No. 5,686,593, U.S. Pat. No. 5,763,254, WO 95/24471, WO 98/12307 and PCT/DK98/00299 are also suitable. Commercially available cellulases include Celluzyme™, and Carezyme™ (Novo Nordisk A/S), Clazinase™, and Puradax HA™ (Genencor International Inc.), and KAC-500(B)™ (Kao Corporation).

Peroxidases/oxidases that may be included in detergent compositions may be of plant, bacterial or fungal origin. Suitable peroxidases include peroxidases from Coprinus and variants thereof. These are described in WO 93/24618, WO 95/10602, and WO 98/15257. Commercially available peroxidases include Guardzyme™ (Novo Nordisk A/S).

The detergent composition of the invention may be in any conventional form (e.g., a bar, a tablet, a powder, a granule, a paste, or a liquid). A liquid detergent may be aqueous or non-aqueous. Where the detergent is aqueous, it typically contains up to 70% water and 0-30% organic solvent.

The detergent comprises one or more surfactants. Such surfactants may be non-ionic, anionic, cationic or zwitterionic. The surfactants are typically present in the detergent at a level ranging from 0.1 percent to 60 percent by weight. Where an anionic surfactant is included, it is usually included at a weight percentage ranging from 1 percent to 40 percent. Non-limiting examples of anionic surfactants include linear alkylbenzenesulfonate, α-olefinsulfonate, alkyl sulfate (fatty alcohol sulfate), alcohol ethoxysulfate, secondary alkanesulfonate, α-sulfo fatty acid methyl ester, alkyl- or alkenylsuccinic acid or soap.

Where a non-ionic surfactant is included in the detergent, it is usually included at a weight percentage ranging from 0.2 percent to 40 percent. Non-limiting examples of non-ionic surfactants include alcohol ethoxylate, nonylphenol ethoxylate, alkylpolyglycoside, alkyldimethylamineoxide, ethoxylated fatty acid monoethanolamide, fatty acid monoethanolamide, polyhydroxy alkyl fatty acid amide, or N-acyl N-alkyl derivatives of glucosamine (“glucamides”).

The detergent may optionally contain one or more of the following: a detergent builder or complexing agent; one or more polymers; a bleaching system; fabric conditioners including clays; foam boosters; suds suppressors; anti-corrosion agents; soil-suspending agents; anti-soil redeposition agents; dyes; bactericides; optical brighteners; hydrotropes; tarnish inhibitors; and, perfumes.

Where a detergent builder or complexing agent is included in the detergent, it is usually included at a weight percentage ranging from 0.01 percent to 65 percent. Non-limiting examples of a detergent builders or complexing agents are zeolites, diphosphates, triphosphates, polyphosphates, phosphonates, carbonates, citrates, nitrilotriacetic acid, ethylenediaminetetraacetic acid, diethylenetriaminepentaacetic acid, alkyl- or alkenylsuccinic acid, soluble silicates or layered silicates (e.g., SKS-6 from Hoechst). Examples of polymers that may be included in the detergent are carboxymethylcellulose, poly(vinylpyrrolidone), poly (ethylene glycol), polylvinyl alcohol), poly(vinylpyridine-N-oxide), poly(vinylimidazole), polycarboxylates such as polyacrylates, maleic/acrylic acid copolymers and lauryl methacrylate/acrylic acid copolymers.

Where a bleaching system is included in the detergent, it is typically a H₂O₂ source such as perborate or percarbonate. The H₂O₂ source may be further combined with a peracid-forming bleach activator such as tetraacetylethylenediamine or nonanoyloxybenzenesulfonate. Alternatively, the bleaching system may comprise peroxyacids of, for example, the amide, imide, or sulfone type.

The following examples are intended to illustrate, but not limit, the invention.

### EXAMPLES

### Example 1

### Elongational Viscosity Measurements

Relative elongational viscosity measurements were conducted in water, 15% propylene glycol in water and 10% sodium chloride in water in order to find the most effective food grade polymer (highest elongational viscosity to concentration ratio). Propylene glycol and sodium chloride are non-solvents for the polymers and hence tend to increase the elongational viscosity at fixed polymer concentration. Relative elongational viscosity values were determined using a packed screen bed modified pipette (25 ml) viscometer. Polyethylene oxide (PEO) was included in the present study as a standard. PEO had the highest elongational viscosity to concentration ratio of all the non food grade polymers examined.

All measurements were made using 0.025 wt % polymer solutions. Flow times through the packed screen bed viscometer were used as an indication of the relative elongational viscosities of the polymers (elongational viscosity is directly proportional to flow times).

TABLE 1
Average elongational viscosity flow times in seconds (standard deviation in parentheses).

| | | 0.025% in | 0.025% in |
|---|---|---|---|
| | | Water containing | Water containing |
| Polymer | 0.025% in Water | 15% propylene glycol | 10% sodium chloride |
| Polyethylene oxide (PEO) | | | |
| Polyox WSR-N60K | 48.3 (1.1) | — | — |
| Hydroxypropylmethylcellulose | | | |
| Methocel K15M | 11.7 (0.1) | — | — |
| Methocel K100M | 15.3 (0.8) | 23.7 (0.7) | — |
| Methocel K250M | 19.1 (0.3) | 30.7 (2.1) | 20.0 (1.3) |
| Carboxymethlycellulose | | | |
| Cellogen HP-12-HS | 28.0 (1.3) | 35.6 (0.7) | — |
| Cellogen 980C | 30.8 (1.2) | — | — |
| Guar Gum | | | |
| Multi-Kem FG60-70 | 19.2 (0.1) | Not | 21.3 (0.3) |
| | | Compatible | |
| Xanthan Gum | | | |
| ISP XG-80 | 18.4 (0.1) | 24.6 (0.2) | 19.0 (0.5) |

Flow time for water without polymer = 10.5 seconds.

### Example 2

### Spray Droplet Size Measurements

An air atomization nozzle from the Buchi Mini Spray Dryer (Model B-191) was used in all experiments. The nozzle orifice was 0.7 mm in diameter. The air pressure for experiments described in Tables 2 and 3 was 60 psi and the fluid flow rate was 74.2 ml/min. The maltodextrin used in the experiments was Maltrin QD M500 produced by Grain Processing Corp., Muscatine, Iowa. Maltodextrin is used as a water soluble substrate for spray dried enzymes.

A Sensadyne Bubble Tensiometer (Model QC 6000) was used to measure dynamic surface tension. Measurements are reported at a bubble frequency of 1.82 bubbles/sec. Spray droplet measurements were made using the Malvern Spraytec Laser Diffraction System.

Spray droplet size measurements at 60 psi are shown in Table 2 for 15% maltodextrin solution and 15% maltodextrin solutions containing 0.025% polymer additive. Maltodextrin at the 15% level does not lower the dynamic surface tension of water (73.3 dynes/cm vs. 72.5 dynes/cm for water) and hence does not lower the Dv(10). The slight increase in Dv(10) for the 15% maltodextrin solution compared to water is probably the result of increased shear viscosity, e.g. thickening.

TABLE 2
Average (standard deviation in parentheses) droplet size
data in μm using Buchi nozzle at 60 psi air pressure.

| | | | | % |
|---|---|---|---|---|
| Solution | Dv(10) | Dv(50) | Dv(90) | Transmission |
| Water | 11.07 (0.15) | 28.74 (0.42) | 59.84 (1.14) | 78.49 (1.92) |
| 15% Malotdextrin | 11.7 (0.25) | 31.39 (0.52) | 69.82 (1.34) | 79.48 (1.67) |
| 0.025% PEO + 15% | 24.11 (1.15) | 75.29 (4.22) | 148.56 (4.23) | 88.37 (0.83) |
| Maltodextrin | | | | |
| 0.025% Methocel | 11.98 (0.73) | 31.86 (1.32) | 69.51 (2.56) | 79.24 (1.7) |
| K250M* + 15% | | | | |
| Maltodextrin | | | | |
| 0.025% Cellogen HP-12- | 13.5 (0.5) | 37.14 (1.39) | 82.89 (3.15) | 81.32 (1.09) |
| HS + 15% Maltodextrin | | | | |
| 0.025% Cellogen 980C + | 14.3 (0.56) | 39.87 (1.58) | 87.93 (3.76) | 79.04 (1.98) |
| 15% Maltodextrin | | | | |

Distance from tip of nozzle to laser beam was 23 inches.
Fluid flow rate was 74.2 ml/min.
*Did not dissolve completely
PEO = polyethylene oxide (Polyox WSR-N60K), Dow Chemical Company, Midland, Michigan.
Methocel K250M = hyrdroxypropylmethylcellulose, Dow Chemical Comapny, Midland, Michigan.
Cellogen = carboxymethylcellulose, Distributed in the US by Montello, Inc.

TABLE 3
Volume percent of droplets less than 10 μm and
greater than 100 μm for solutions at 60 psi.

| | Volume % droplets | Volume % droplets |
|---|---|---|
| Solution | less than 10 μm | greater than 100 μm |
| Water | 8.0 | 1.2 |
| 15% Maltodextrin | 7.4 | 3.1 |
| 0.025% PEO + 15% | 1.2 | 29.0 |
| Maltodextrin | | |
| 0.025% Methocel K250M + | 7.4 | 3.1 |
| 15% Maltodextrin | | |
| 0.1% Cellogen HP-12-HS + | 5.5 | 5.5 |
| 15% Maltodextrin | | |
| 0.025% Cellogen 980C + | 4.9 | 6.6 |
| 15% Maltodextrin | | |

Tables 2 and 3 show that the ability of a polymer to reduce fines in a spray application is directly proportional to its elongational viscosity, shown in Table 1.

### Example 3

### Spray Drying in Presence of High MW Polymer

Fifteen percent (15%) Maltodextrin solutions containing low levels of high MW food grade polymer were spray dried using a Buchi Mini Spray Dryer (Model B-191). The Maltodextrin used in the experiments was Maltrin QD M500 produced by Grain Processing Corp., Muscatine, Iowa. Maltodextrin is used as a water soluble substrate for spray dried enzymes. High MW food grade polymers were added to 15% Maltodextrin solution based on their ability to increase the elongational viscosity of the solution and hence increase the average particle size of the spray.

A schematic diagram of the Spray Dryer is shown in FIG. 1. The following conditions were fixed for each of the runs: Inlet Temperature: 170° C.; Atomizing Air Flow Setting: 800; Spray Solution Pump: 15% (˜5.8 ml/min); Insulate Spray Chamber Receiver (11 in FIG. 1); The nozzle was cooled with water.

The aspirator pump capacity was increased from 80% to 90% to 100% during the run and the outlet temperature readings and vacuum gauge readings were recorded as a function of time in order to assess the quantity of fine solid particles exiting the cyclone and being trapped on the bag filter (9 in FIG. 1). The percentage yield of product collected in the cyclone (8 in FIG. 1) was also measured. The bag filter was cleaned after each run to assure that the initial vacuum gauge reading was the same for each run.

The aspirator settings, outlet temperature reading and vacuum reading on the backside of the filter bag were taken as a function of time for each of the eight spray dry runs. The final readings at 45 minutes into each run are summarized below in Table 4 (elongational viscosity flow times and dynamic surface tension for the spray solutions are also listed). The generation of high levels of fine particles results in higher levels of accumulation in the filter bag, increasing the vacuum (from −35 mbar to −70 mbar in Table 4 below) and decreasing the outlet temperature, Tₒᵤₜₗₑₜ. The increase in vacuum and decrease in outlet temperature lead to inefficient spray dryer performance.

TABLE 4
Conditions at End (45 min) of Spray Dry Runs
Spray Solution: 15% Maltodextrin + Additives

| | | Elongational | | | |
|---|---|---|---|---|---|
| | | Viscosity Flow | DST* | | Vacuum |
| Run # | Additives | Times (sec) | (dynes/cm) | Tₒᵤₜₗₑₜ (° C.) | (mbar) |
| 1 | — | — | 73.3 | 70 | −70 |
| 5 | 0.01% Cellogen 980C | — | — | 77 | −62 |
| 6 | 0.025% Cellogen 980C + | 30.8 | 52.2 | 77 | −60 |
| | 3% Aquacoat ECD | | | | |
| | (solids)** | | | | |
| 2 | 0.0025% PEO | — | — | 83 | −57 |
| 7 | 0.025% Cellogen 980C + | 30.8 | 62.6 | 82 | −57^{†} |
| | 5% Joncryl 2153 | | | | |
| | (solids)*** | | | | |
| 3 | 0.025% Cellogen HP-12- | 28.0 | 73.1 | 86 | −56 |
| | HS | | | | |
| 4 | 0.025% Cellogen 980C | 30.8 | 73.4 | 93 | −47 |
| 8 | 0.01% PEO | — | — | 94 | −35^{‡} |

*Dynamic Surface Tension at 1.82 bubbles/sec
**Ethyl Cellulose (Glass Transition Temperature = 90° C.)
***Acrylic Polymer (Glass Transition Temperature = 75° C.)
^{†}Reduced rate of Maltodextrin solubilization when spray dry particle was placed in water
^{‡}Spray chamber walls were wet

In Table 4, the runs are listed in order of increasing outlet temperature and decreasing vacuum reading at 45 minutes. Run 1 (15% Maltodextrin with no polymer additives) resulted in the lowest outlet temperature and highest vacuum reading. This indicated Run 1 had the highest level of fine Maltodextrin solid particles collected on the filter bag. From the results in Table 4, the food grade polymer Cellogen 980C (Carboxymethylcellulose) used at 0.025% (Run 4) was very effective in reducing the mass of maltodextrin fines collected on the filter bag. Cellogen HP-12-HS (Carboxymethylcellulose with a lower degree of substitution and lower elongational viscosity than Cellogen 980C) is not quite as effective (Run 3) as Cellogen 980C in reducing the mass of fines collected on the filter bag. The PEO standard (non-food grade) was effective as 0.025% Cellogen 980C in reducing fines when used at a level between 0.0025% and 0.01% (0.0025% PEO was not as effective as 0.025% Cellogen 980C and 0.01% PEO resulted in too large spray particles which led to incomplete drying and wet drying chamber walls).

### Example 4

### Spray Drying of Enzyme in Presence of High MW Polymer

Approximately fifteen percent (15% w/w) solutions of protease enzyme and maltodextrin (6.5% enzyme solids and 8% maltodextrin solids) with and without a low level of high MW food grade polymer were spray dried using a Buchi Mini Spray Dryer (Model B-191). The Maltodextrin used in the experiments was Maltodextrin M150 produced by Grain Processing Corp., Muscatine, Iowa.

A schematic diagram of the Spray Dryer is shown in FIG. 1. The following conditions were fixed for both of the runs: Inlet Temperature: 170° C.; Atomizing Air Flow Setting: 500 l/hr; Spray Solution Pump: 15% (˜5.6 ml/min); Aspirator pump: 100%: and the nozzle was cooled with running cold tap water.

The vacuum gauge readings were recorded as a function of time in order to assess the quantity of fine solid particles exiting the cyclone and being trapped on the bag filter (9 in FIG. 1). The percentage yield of product collected in the cyclone (8 in FIG. 1) was also measured. The bag filter was cleaned after each run to assure that the initial vacuum gauge reading was the same for each run.

The outlet temperature reading and vacuum reading on the backside of the filter bag were taken as a function of time for each of the spray dry runs. The readings are summarized below in Table 5. The generation of high levels of fine particles results in higher levels of accumulation in the filter bag, which increases the vacuum and decreases the outlet temperature. The increase in vacuum and decrease in outlet temperature lead to inefficient spray dryer performance.

TABLE 5
Outlet Temperature and Vacuum Readings

| | |
|---|---|
| Outlet Temp, ° C. | Vacuum, −mbar |

| Time, min | Enzyme | +980C | Enzyme | +980C |
|---|---|---|---|---|
| 0 | 92 | 91 | 38 | 38 |
| 3 | 93 | 95 | 39 | 38 |
| 5 | 91 | 94 | 41 | 38 |
| 10 | 86 | 92 | 51 | 41 |
| 15 | 82 | 89 | 59 | 49 |
| 20 | 79 | 85 | 61 | 55 |
| 25 | 76 | 82 | 63 | 58 |
| 30 | 75 | 80 | 65 | 61 |
| 35 | 74 | 78 | 68 | 63 |
| 40 | 72 | 76 | 69 | 64 |
| 44 | | 76 | | 65 |
| 45 | 72 | | 69 | |

Yields were calculated for both runs for different sections of the spray dryer. There were no particles in the Receiver (11 in FIG. 1) for the enzyme/maltodextrin run, but there were particles collected in the Receiver for the Cellogen 980C run. The Receiver collects the coarsest particles that are too heavy to be carried into the cyclone. The yield in the cyclone and its collection vessel (4 & 8 in FIG. 1) was greater for the Cellogen 980C run than for the enzyme/maltodextrin run. The cyclone and its collection vessel are the main accumulation points for the spray dried product. The yield in the filter unit was lower for the Cellogen 980C run compared to the enzyme/maltodextrin run. The yield in the filter unit is a measure of the amount of fine particles collected. The yields for various section of the spray dryer are summarized in Table 6.

TABLE 6
End of Run Yields in Various Sections of the Spray Dryer

| | Receiver | Cyclone | Filter Unit |
|---|---|---|---|
| | Yield, % | Yield, % | Yield, % |
| Enzyme + Maltodextrin | 0 | 43.7 | 4.2 |
| +0.025% Cellogen 980C | 0.4 | 66.1 | 1.5 |

From the results in Tables 5 and 6, the food grade polymer, Cellogen 980C (Carboxymethylcellulose) used at 0.025%, was more effective at maintaining the outlet temperature and resulted in a smaller increase in the vacuum pressure compared to the no polymer control. The addition of 0.025% Cellogen 980C increased the production of coarse particles collected in the Receiver, increased the product yield in the Cyclone, and decreased the yield of fine particles in the filter unit.

Although the foregoing invention has been described in some detail by way of illustration and examples for purposes of clarity of understanding, it will be apparent to those skilled in the art that certain changes and modifications may be practiced without departing from the spirit and scope of the invention. Therefore, the description should not be construed as limiting the scope of the invention, which is delineated by the appended claims.

All publications, patents, and patent applications cited herein are hereby incorporated by reference in their entireties for all purposes and to the same extent as if each individual publication, patent, or patent application were specifically and individually indicated to be so incorporated by reference.

We claim:

1. A method of spray drying an aqueous composition, comprising:
(a) introducing an aqueous composition into a spray drying apparatus, wherein said aqueous composition comprises 0.001 to 0.10 weight percent of a high molecular weight, water soluble, flexible polymer comprising a molecular weight of 300,000 Daltons to 4,000,000 Daltons, and a polypeptide; and
(b) spray drying the aqueous composition to produce particles.

2. A method according to claim 1, wherein the polymer is selected from a cellulose-based polymer, a gum, and a synthetic polymer.

3. A method according to claim 1, wherein the polymer is polyethylene oxide.

4. A method according to claim 1, wherein the polymer is carboxymethyl cellulose.

5. A method according to claim 1, wherein the polypeptide is an enzyme.

6. A method according to claim 5, wherein the enzyme is selected from an oxidoreductase, a transferase, a hydrolase, a lyase, an isomerase, and a ligase.

7. A method according to claim 1, wherein the yield of particles is increased by at least 5 percent relative to an identical process wherein the aqueous composition does not comprise the polymer.

8. An atomized aqueous composition, comprising 0.001 to 0.10 weight percent of a high molecular weight, water soluble, flexible polymer comprising a molecular weight of 300,000 Daltons to 4,000,000 Daltons, and a polypeptide, wherein said atomized aqueous composition is produced in a spray drying apparatus, wherein the Dv(50) of said composition at least 10 percent higher relative to an identical composition that does not comprise the polymer.

9. A composition according to claim 8, wherein the polymer is selected from a cellulose-based polymer, a gum, and a synthetic polymer.

10. A composition according to claim 8, wherein the polymer is polyethylene oxide.

11. A composition according to claim 8, wherein the polymer is carboxymethyl cellulose.

12. A composition according to claim 8, wherein the polypeptide is an enzyme.

13. A composition according to claim 12, wherein the enzyme is selected from an oxidoreductase, a transferase, a hydrolase, a lyase, an isomerase, and a ligase.

14. A detergent composition comprising a particle produced according to claim 1.
